(19) United States
(12) Patent Application Publication
(10) Pub. No.: US 2021/0325229 A1
(43) Pub. Date: Oct. 21, 2021

(54) STOCK TANK WATER LEVEL MEASURING APPARATUS AND SYSTEM FOR MONITORING THE APPARATUSES

(71) Applicant: Wellbot LLC, Buckley, WA (US)

(72) Inventors: David Cliff, Buckley, WA (US); Curt Goble, Yuma, CO (US)

(73) Assignee: Wellbot LLC

(21) Appl. No.: 17/236,199

(22) Filed: Apr. 21, 2021

Related U.S. Application Data
(60) Provisional application No. 63/013,135, filed on Apr. 21, 2020.

(51) Int. Cl. G01F 23/18; G01K 13/00; H04Q 9/00

(52) U.S. Cl. CPC G01F 23/18; H02S 40/38; H04Q 9/00; G01K 13/00

(57) ABSTRACT

A water level measuring apparatus for a water storage container. The water level measuring apparatus includes a water pressure sensor disposed at a bottom of the water storage container to generate water pressure data and a controller for determining a water level in the water storage container based upon the water pressure data generated by the water pressure sensor. A water monitoring system including a water level measuring apparatus to determine pressure data associated with a water container. The water monitoring system also includes a water level control system that sends and receives information from the water level measuring apparatus. A method of monitoring water levels in water containers. Water pressure data is captured from the water containers. The pressure data is sent from the water level measuring apparatus of the water monitoring system to the water level control system of the water monitoring system. Water depth data is generated for the water containers from the pressure data.

### CROSS-REFERENCE TO RELATED APPLICATIONS

The present application is a conversion of U.S. Provisional Application having U.S. Ser. No. 63/013,135, filed Apr. 21, 2020, which claims the benefit under 35 U.S.C. 119(e). The disclosures of which are hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to an apparatus for measuring the water level in a fluid containment system and a system for monitoring multiple water level measuring apparatuses for numerous fluid containment systems.

### 2. Description of the Related Art

Typically, stock tanks are positioned on farms or ranches at locations that are spread out over a large property area. Farmers and ranchers have to take the time to travel to each one of the stock tanks to determine, via a visual inspection, whether they have enough water. To do this takes considerable time. In some situations, the design of some stock tanks may make visual inspection of the water level more difficult.

Accordingly, there is a need for a water level measuring apparatus to measure the water level in stock tanks to provide a reliable measurement of the amount of water in each stock tank. Furthermore, there is a need for a system to monitor multiple water level measuring apparatuses so the farmer or the rancher does not have to take the time to travel to all the stock tank locations spread across the farm or ranch.

### SUMMARY OF THE DISCLOSURE

The present disclosure is directed to a water level measuring apparatus for a water storage container. The water level measuring apparatus includes a water pressure sensor disposed at a bottom of the water storage container to generate water pressure data and a controller for determining a water level in the water storage container based upon the water pressure data generated by the water pressure sensor. The disclosure is also directed to a water monitoring system. The water monitoring system including a water level measuring apparatus to determine pressure data associated with a water container. The water monitoring system also includes a water level control system that sends and receives information from the water level measuring apparatus.

The present disclosure also describes a method of monitoring water levels in water containers via the water monitoring system. Water pressure data is captured from the water containers. The pressure data is sent from the water level measuring apparatus of the water monitoring system to the water level control system of the water monitoring system. Water depth data is generated for the water containers from the pressure data.

### BRIEF DESCRIPTION OF THE DRAWINGS

FIG. 1 is a perspective view of a water level measuring apparatus constructed in accordance with the present disclosure.

FIG. 2 is another perspective view of the water level measuring apparatus constructed in accordance with the present disclosure.

FIG. 3 is a side-elevation view of the water level measuring apparatus constructed in accordance with the present disclosure.

FIG. 4 is a schematic view of a water monitoring system constructed in accordance with the present disclosure.

FIG. 5 is a schematic view of a water level control system constructed in accordance with the present disclosure.

### DETAILED DESCRIPTION OF THE DISCLOSURE

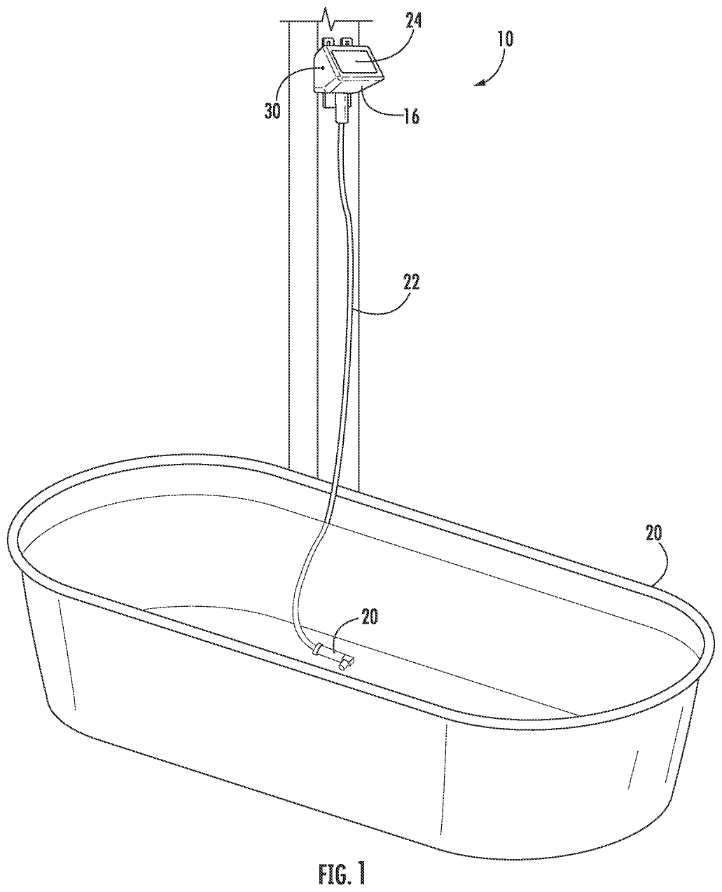

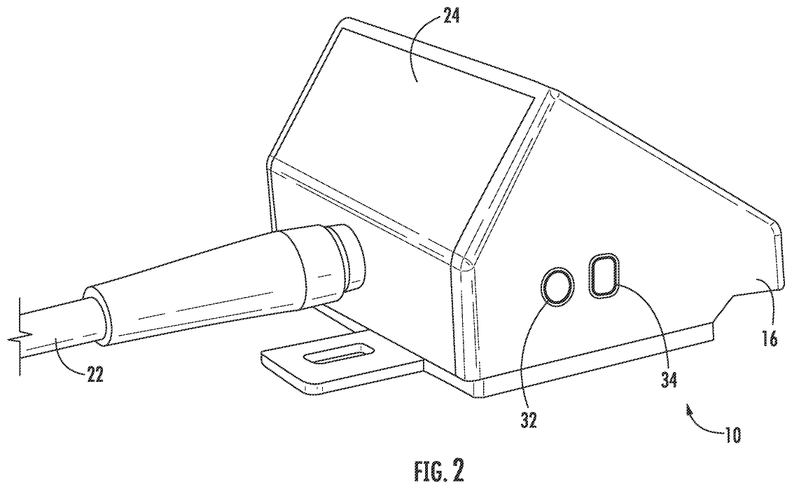

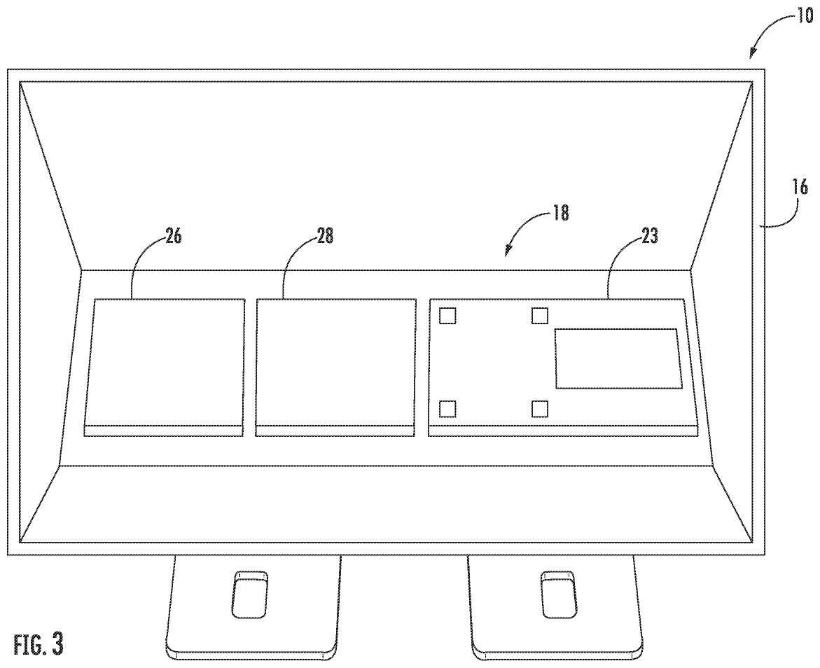

Referring now to FIGS. 1-3, the present disclosure is related to a water level measuring apparatus 10 to be implemented with a remotely placed water storage container 12, such as a stock tank, a natural pond or a man-made pond, to determine the water level in the water storage container 12. This disclosure is also directed to a water monitoring system 14 in communication with the water level measuring apparatuses 10 to monitor multiple water storage containers 12 located around a farm or ranch. It should be understood and appreciated that the water level measuring apparatus 10 described herein could be used with any type of fluid and any type of fluid storage container, and the apparatus is not limited to use solely on farms and ranches.

The water level measuring apparatus 10 can include a housing 16 for encasing various electronic components 18 required to operate the water level measuring apparatus 10. The electronic components 18 in the housing 16 can include a controller (or processor) for operating various aspects of the water level measuring apparatus 10 and a memory for storing the data gathered by the water level measuring apparatus 10 and data stored in the water level measuring apparatus 10. The water level measuring apparatus 10 can include a modem and an antenna to send and receive data from the water level measuring apparatus 10. In one embodiment, the modem can be a cellular modem that can send and receive data via a cellular tower. The water level measuring apparatus 10 can also include a water pressure sensor 20 to determine the height of the water in the water storage container 12. The pressure sensor 20 is in communication with the controller via a communication link 22. The communication link 22 can be wired or wireless. If the communication is wireless, the water pressure sensor 20 will require various known electronic components to make it operable with the water level measuring apparatus 10, such as a controller/processor 23, memory and data transmission hardware.

In one embodiment of the present disclosure, the water level measuring apparatus 10 can also include a modem and an antenna to send and receive data from the water level measuring apparatus 10. In one embodiment, the modem can be a cellular modem that can send and receive data via a cellular tower. In a further embodiment, the water level measuring apparatus 10 can include a photovoltaic (solar) panel 24 supported by the housing 16 of the water level measuring apparatus 10 to generate power from the sun. The water level measuring apparatus 10 can also include a charge controller 26 to capture the power generated by the solar panel 24 and stores it in a battery 28 so that the water level measuring apparatus 10 can run day and night. The water level measuring apparatus 10 can further include a protective equalization port 30 that permits the water level measuring apparatus 10 to equalize pressure and temperature within the water level measuring apparatus 10 without permitting moisture to get inside and damage the water level measuring apparatus 10.

In yet another embodiment, the water level measuring apparatus 10 includes a power button 32 disposed in the housing 16 for turning the water level measuring apparatus 10 on and off and an indicator light 34 to provide notice when the water level measuring apparatus 10 is operational. In a further embodiment, the indicator light 34 can be configured to blink in various patters to indicate a certain operation is currently underway. For example, the indicator light 34 might blink rapidly to indicate that the water level measuring apparatus 10 is running and the indicator light 34 might blink slowly to indicate that the water level measuring apparatus 10 is sending or receiving data. The indicator light 34 could blink in another pattern if there is an error with the water level measuring apparatus 10.

The water pressure sensor 20 can be a pressure sensor (transducer) that sits at the bottom of the water storage container 12. The pressure of the water is a function of the weight of the water above the pressure sensor (and thus the bottom of the water storage container 12) and the atmospheric pressure of the air around the water storage container 12. The processor 23, using the weight of the water above the pressure sensor 20 and the atmospheric pressure creates a gauge pressure. The processor 23 can use the gauge pressure data to generate the height of the water disposed above the pressure sensor 20, and thus the height of the water in the water storage container 12. The pressure sensor 20 can also determine and capture temperature information. The temperature information can be relayed to the water level measuring apparatus 12 to alert the end user when the water in the water storage container 12 is close to freezing.

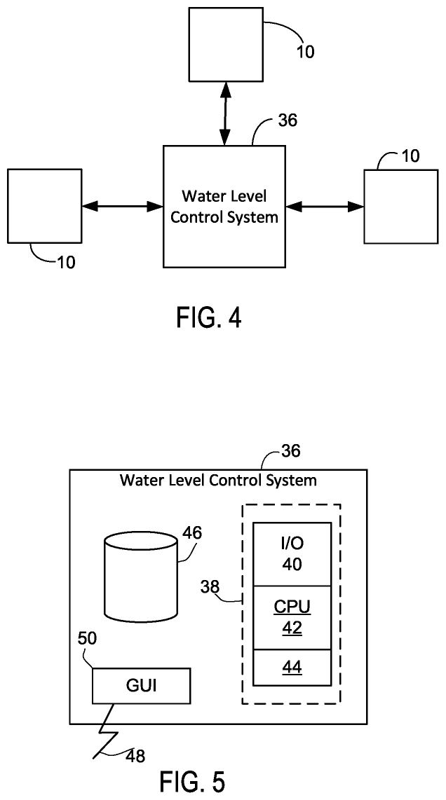

The present disclosure is also directed to a water level control system 36 in communication with multiple water level measuring apparatuses 10 to monitor multiple water storage containers 12 located around a farm or ranch. This relationship between the water level control system 36 and multiple water level measuring apparatuses 10, and thus multiple water storage containers 12 of the water monitoring system 14, is shown in FIG. 4. Referring now to FIG. 5, shown therein is a diagram of the water level control system 36. The water level control system 36 is capable of executing a computer program product embodied in a tangible processor-readable storage medium to execute a computer process. Data and program files may be input to the water level control system 36, which reads the files and executes the programs therein using one or more processors. Some of the elements of the water level control system 36 are shown in FIG. 5, wherein a processor 38 is shown having an input/output (I/O) section 40, a Central Processing Unit (CPU) 42, and a memory section 44. There may be one or more processors 38, such that the processor 38 of the water level control system 36 comprises a single central-processing unit 42, or a plurality of processing units. The processors may be single-core or multi-core processors. The water level control system 36 may be a conventional computer, a distributed computer, or any other type of computer. The described technology is optionally implemented in software loaded in memory 44, a disc storage unit 46, and/or communicated via a wired or wireless network link 48 on a carrier signal (e.g., Ethernet, 3G wireless, 1G wireless, LTE (Long Term Evolution), 5G) thereby transforming the water level control system 36 in FIG. 5 to a special purpose machine for implementing the described operations.

The I/O section 40 may be connected to one or more user-interface devices (e.g., a keyboard, a touch-screen display unit, graphical user interface, etc.) or a disc storage unit 46. Computer program products containing mechanisms to effectuate the systems and methods in accordance with the described technology may reside in the memory section 44 or on the storage unit 46 of the water level control system 36.

The water level control system 36 can also include a communication interface 50 capable of connecting the water level control system 36 to an enterprise network via the network link 52, through which the water level control system 36 can receive instructions and data embodied in a carrier wave. When used in a local area networking (LAN) environment, the water level control system 36 is connected (by wired connection or wirelessly) to a local network through the communication interface 50, which is one type of communications device. When used in a wide-area-networking (WAN) environment, the water level control system 36 typically includes a modem, a network adapter, or any other type of communications device for establishing communications over the wide-area network. In a networked environment, program modules depicted relative to the water level control system 36 or portions thereof may be stored in a remote memory storage device. It is appreciated that the network connections shown are examples of communications devices for and other means of establishing a communications link between the computers may be used.

In an example implementation, a browser application, a compatibility engine applying one or more compatibility criteria, and other modules or programs may be embodied by instructions stored in memory 44 and/or the storage unit 46 and executed by the processor 38. Further, local computing systems, remote data sources and/or services, and other associated logic represent firmware, hardware, and/or software, which may be configured to assist in monitoring and managing the water level measuring apparatuses 10. The water level control system 36 may be implemented using a general-purpose computer and specialized software (such as a server executing service software), a special purpose computing system and specialized software (such as a mobile device or network appliance executing service software), or other computing configurations. In addition, user requests, profiles and parameter data, agent profiles and parameter data, location data, parameter matching data, and other data may be stored in the memory 44 and/or the storage unit 46 and executed by the processor 38.

The embodiments of the invention described herein are implemented as logical steps in one or more computer systems. The logical operations of the present invention are implemented (1) as a sequence of processor-implemented steps executed in one or more computer systems and (2) as interconnected machine or circuit modules within one or more computer systems. The implementation is a matter of choice, dependent on the performance requirements of the computer system implementing the invention. Accordingly, the logical operations making up the implementations of the invention described herein are referred to variously as operations, steps, objects, or modules. Furthermore, it should be understood that logical operations may be performed in any order, adding and omitting as desired, unless explicitly claimed otherwise or a specific order is inherently necessitated by the claim language.

Data storage and/or memory may be embodied by various types of storage, such as hard disk media, a storage array containing multiple storage devices, optical media, solid-state drive technology, ROM, RAM, and other technology. The operations may be implemented in firmware, software, hard-wired circuitry, gate array technology and other technologies, whether executed or assisted by a microprocessor, a microprocessor core, a microcontroller, special purpose circuitry, or other processing technologies. It should be understood that a write controller, a storage controller, data write circuitry, data read and recovery circuitry, a sorting module, and other functional modules of a data storage system may include or work in concert with a processor for processing processor-readable instructions for performing a system-implemented process.

For purposes of this description and meaning of the claims, the term “memory” (e.g., memory 144) means a tangible data storage device, including non-volatile memories (such as flash memory and the like) and volatile memories (such as dynamic random-access memory and the like). The computer instructions either permanently or temporarily reside in the memory, along with other information such as data, virtual mappings, operating systems, applications, and the like that are accessed by a computer processor to perform the desired functionality. The term “memory” or “storage medium” expressly does not include a transitory medium, such as a carrier signal, but the computer instructions can be transferred to the memory wirelessly.

The water level control system 36 can send and receive data to and from the water level measuring apparatuses 10. The water level control system 36 can further facilitates communication of the data from the water level measuring apparatuses 10. In one embodiment, an app (or computer program) can be downloaded to a computing device (such as a phone or tablet) and stored on the computing device's memory to essentially make the computing device act as the water level control system 36. The app includes software that is downloaded to a computing device's processor so that the computing device can operate as the water level control system 36.

The water monitoring system 14 can show the current water level, water temperature, battery level and approximate location of each water storage container 12 associated with each water level measuring apparatus 10. The water monitoring system 14 can also show if there is an issue with a water level measuring apparatus 10. An alert can be sent to the water monitoring system 14 and seen by the user if there is an alert condition with the water level measuring apparatus 10. The water monitoring system 14 can be set up such that if an alert condition is present, the water level control system 36 can send a message to the computing device. In one embodiment, the water level control system 36 can send a message to a cell phone, via any messaging means known in the art, such as a text message, to notify the user of the alert condition. In another embodiment, the computing device can be a cell phone and the message can be a notification on the cell phone. The alert condition can be related to water level, water temperature, batter level and any other operational aspects of the water level measuring apparatus 10. The water monitoring system 14 can be set up so that alerts can be sent out to multiple cell phones (or other computing devices). The water level control system 36 can receive pressure data (atmospheric and water pressure data from the pressure sensor) from the water level measuring apparatus 10 and the water level control system 36 can generate water height or depth data for the water container 12 associated with the water level measuring apparatus 10.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. A water level measuring apparatus for a water storage container, the apparatus comprising:
a water pressure sensor disposed at a bottom of the water storage container to generate water pressure data; and
a controller for determining a water level in the water storage container based upon the water pressure data generated by the water pressure sensor.

2. The water level measuring apparatus of claim 1 further comprising a solar panel for transforming energy from the sun to energy that can be stored on a battery of the water level measuring apparatus.

3. The water level measuring apparatus of claim 1 further comprising a communication link between the water pressure sensor and the controller wherein the communication link is wired or wireless.

4. The water level measuring apparatus of claim 2 further comprising a charge controller to facilitate capturing the energy from the solar panel and transferring the energy to the battery.

5. The water level measuring apparatus of claim 1 further comprising an indicator light that operates responsive to a condition the water level measuring apparatus experiences.

6. The water level measuring apparatus of claim 1 wherein the water pressure sensor can also determine the temperature of the water in the water storage container and can provide the temperature to the controller.

7. A water monitoring system, the water monitoring system comprising:
a water level measuring apparatus to determine pressure data associated with a water container; and
a water level control system that sends and receives information from the water level measuring apparatus.

8. The water monitoring system of claim 7 wherein the information sent from the water level measuring apparatus is water pressure data, atmospheric data or water temperature data.

9. The water monitoring system of claim 7 wherein there are multiple water level measuring apparatuses monitored by the water monitoring system.

10. The water monitoring system of claim 7 wherein the water level control system displays data from the water level measuring apparatus.

11. The water monitoring system of claim 7 wherein the water level control system receives pressure data from the water level measuring apparatus and the water level control system generates water depth data for the water container associated with the water level measuring apparatus.

12. The water monitoring system of claim 7 wherein water level measuring apparatus comprises:
a water pressure sensor disposed at a bottom of the water storage container to generate water pressure data; and
a controller for determining a water level in the water storage container based upon the water pressure data generated by the water pressure sensor.

13. The water level measuring apparatus of claim 12 further comprising a solar panel for transforming energy from the sun to energy that can be stored on a battery of the water level measuring apparatus.

14. The water level measuring apparatus of claim 12 further comprising a communication link between the water pressure sensor and the controller wherein the communication link is wired or wireless.

15. The water level measuring apparatus of claim 2 further comprising a charge controller to facilitate capturing the energy from the solar panel and transferring the energy to the battery.

16. A method of monitoring water levels in water containers via a water monitoring system, the method comprising:
capturing pressure data from water in a water container;
sending the pressure data from a water level measuring apparatus of the water monitoring system to a water level control system of the water monitoring system; and
generating water depth data of the water container from the pressure data.

17. The method of claim 16 wherein there are multiple water level measuring apparatuses monitored by the water monitoring system.

18. The method of claim 16 further comprising displaying the water depth data via the water level control system.

19. The method of claim 16 wherein the water monitoring system can send messages to a computing device regarding information or conditions associated with the water level measuring apparatus.

20. The method of claim 16 wherein the water level measuring apparatus can measure the temperature of the water in the water container and provide this information to the water level control system
